(19) United States
(12) Patent Application Publication
(10) Pub. No.: US 2002/0198749 A1
(43) Pub. Date: Dec. 26, 2002

(54) System and method for bandwidth management, pricing, and capacity planning

(76) Inventors: John A. Tomlin, Sunnyvale, CA (US); Xin Guo, Mount Kisco, NY (US)

Correspondence Address: McGuireWoods, LLP, 1750 Tysons Boulevard, Suite 1800, McLean, VA, 22102-3915, US

(21) Appl. No.: 09/881,025

(22) Filed: Jun. 15, 2001

(51) Int. Cl. G06F 17/60

(52) U.S. Cl. 705/7

(57) ABSTRACT

A bandwidth management system combines a chance constrained optimization model with variable pricing as a tool for bandwidth management. Performance analysis and capacity planning are integrated with the pricing scheme. This is a discretized multi-time-period model, where the time t is specified in terms of multiples τ of a fixed period length Δ.

### BACKGROUND OF THE INVENTION

1. Field of the Invention

The present invention generally relates to buying and selling bandwidth and, more particularly, to a system which combines chance constrained programming with variable pricing as a tool for bandwidth management.

2. Description of the Related Art

The bandwidth of a transmitted communications signal is a measure of the range of frequencies the signal occupies. All transmitted signals, whether analog or digital, have a certain bandwidth. As large communications companies expand the capabilities of their current systems with vast new high-speed networks to meet projected future demands, they inevitably create surplus bandwidth in the present.

Bandwidth is traded like a commodity or security. The current growth of the bandwidth market, driven by increasing Internet use and electronic commerce, is running somewhere between 25% and 40% a year. By 2005, it has been predicted by some that the bandwidth trading market in the U.S. may be more than $400 billion.

Consider a re-seller who buys surplus bandwidth in bulk from a large communication company and resells it in smaller bundles to customers. These bundles correspond to “contracts” made with customers to supply bandwidth in standard quantities for a specific time span. The type of contract bought defines a “customer class” or “customer type”.

A customer class i is defined by the parameters μᵢ and σ²ᵢ which are the mean and variance of the (normal) distribution describing this class of user's consumption of bandwidth.

### SUMMARY OF THE INVENTION

A question arises as to how the reseller should price these contracts. The reseller must not only choose prices which will attract customers, but also make sure that these customers do not collectively exceed the bandwidth available (i.e. sold). Since the behavior of the end users is neither deterministic nor under the re-seller's control, we shall take this to mean that given the distribution of individual customer bandwidth consumption, the total available shall not be exceeded with some (high) probability at any time t within the planning horizon. This is accomplished by means of “chance-constraining” total bandwidth consumption.

The present invention is directed to a system which combines a chance constrained optimization model with variable pricing as a tool for bandwidth management. Performance analysis and capacity planning are integrated with the pricing scheme. This is a discretized multi-time-period model, where the time t is specified in terms of multiples τ of a fixed period length Δ.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a flow diagram showing the data acquisition and input steps according to the present invention; and

FIG. 2 is a flow diagram showing the optimization and output steps for determining a price structure for contracts offered to clients.

### DETAILED DESCRIPTION OF A PREFERRED EMBODIMENT OF THE INVENTION

A “chance constraint” is an inequality on the variables in the model that must be satisfied with some probability less than 1, in contrast to ordinary constraints, which must be completely satisfied (i.e. with probability 1).

We illustrate this approach considering only one class of customer. For any fixed time t, let

Yₜ=X₁+X₂+. . . +X_{N(t)}

where (we assume) the Xᵢ's are identical independent normal distributed random variables with mean μ and variance σ², which represent the real usage of N(t) customers. Y(t) is then the random variable representing the total bandwidth consumption of these N(t) customers at time t. Further assuming that customers arrival is described by a Poisson distribution with λ=λ(t), independent of Xᵢ, then:

$$P ( N ( t ) = k ) = [ \frac{{( λ ( t ) )}^{k} {ⅇ}^{- λ ( t )}}{k !} ] .$$

The parameter λ(t) will be related to the price set, as we shall discuss below.

To specify that the customers' collective bandwidth consumption Y(t) does not exceed the available bandwidth bₜ, with some (high) probability δₜ, we impose the chance constraint:

P(Yₜ>bₜ)≦δₜ,

The invention requires that this chance constraint be expressed in a computationally tractable way. This is carried out using standard techniques from probability theory (see e.g. W. Feller, An Introduction to Probability Theory and its Applications, Vol 1 (3^{rd} edition), (1968) and Vol 2, Wiley, N.Y. (1971)) as follows:

Define the moment generating function for Yₜ:

Ψᵣ(Yₜ)=E[e^{ryt}],

and note that E[Yₜ²] can be derived from this moment generating function via the relation:

$$E [ {Y}_{t}^{2} ] = \frac{{\partial }^{2} {ψ}_{r} ( {Y}_{t} )}{\partial {r}^{2}} \vert r = 0.$$

which on differentiating, yields:

E[Yₜ²]=λ(t)σ²+λ(t)μ²+(λ(t))²μ².

Applying the Chebyshev bound we also derive:

$$P ( {Y}_{t} > {b}_{t} ) \leq \frac{E [ {Y}_{t}^{2} ]}{{b}_{t}^{2}}$$

hence, using our expression for E[Yₜ²], we see that the chance constraint is satisfied if:

λ(t)σ²+λ(t)μ²+(λ(t))²μ²≦δₜbₜ².

This derivation may be generalized to multiple customer classes and multiple discrete time periods, and is applied in the most general form of the invention.

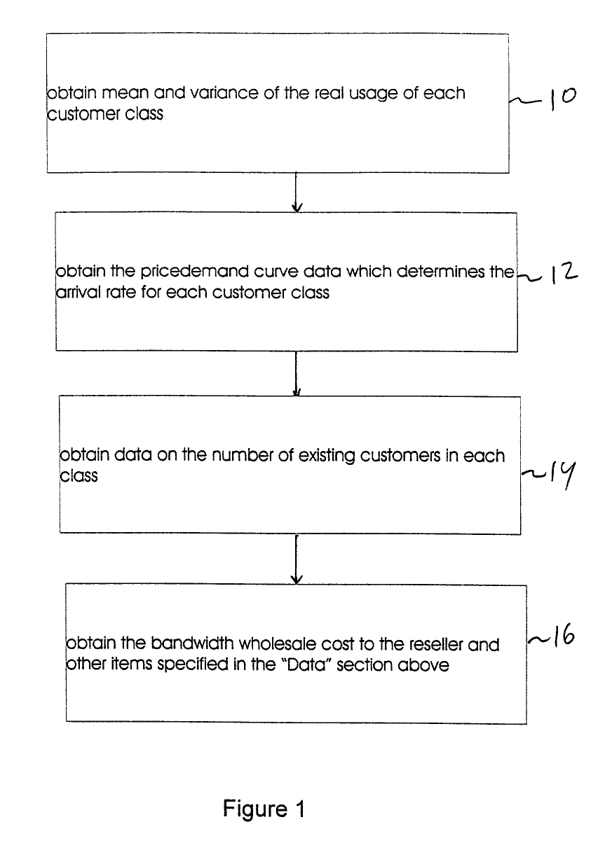

Referring now to the drawings, and more particularly to FIG. 1 there is shown a flow diagram showing the data acquisition and input steps according to the present invention for optimizing bandwidth management with multiple types of contracts.

Below are listed the notations, assumptions, and data for implementing the present invention.

Indices

i=1, . . . , I: customer class;

τ=1, . . . , T: time periods, each of length Δ.

Assumptions

For any fixed time t, real usages of signed-on customers for class i are identical independent normal distribution with mean μᵢ (t) and variance σᵢ²(t);

Number of customers of class i is Poisson with parameter λᵢ, itself a function of price (see below).

Data

δ_{τ}: tolerance on capacity violation in period τ;

C_{τ}: cost per unit of buying new capacity in period τ;

d_{τ}: duration of contract (number of time periods) for customer class i;

Dᵢ: actual duration of contract (dᵢΔ) for customer class i;

n_{iτ}: number of existing contracts of type i still active at start of period τ;

L_{iτ}: lower bound on contract price;

U_{iτ}: upper bound on contract price.

Variables

b_{τ}: the bandwidth available in period τ (non-negative);

a_{τ}: bandwidth purchased by re-seller in period τ (non-negative);

q_{iτ}: price to new (or renewing) customers for a new standard length contract of type i in period τ.

User Supplied Functions

λᵢ(q_{iτ}): the expected number of new customers of type i arriving in any period if the price for a contract is set at q_{iτ}.

These are standard price-demand curves reflecting the elasticity of demand.

Constraints

In addition to the constraint on the availability of the bandwidth at each time r and on the price range, it is required that the total available shall not be exceeded with some (high) probability at any time t within the planning horizon:

b_{τ}=b_{τ-1}+a_{τ}(τ=1, . . . , T) (1)

L_{iτ}≦q_{iτ}≦U_{iτ}(i=1, . . . , I; τ=1, . . . , T) (2)

$${\sum }_{i \vert τ < {d}_{i}} [ {λ}_{i τ} Δ {μ}_{i}^{2} + {( {n}_{i τ} + {λ}_{i τ} Δ )}^{2} {σ}_{i}^{2} + {( {n}_{i τ} + {λ}_{i τ} Δ )}^{2} {μ}_{i}^{2} ] + {\sum }_{i \vert τ \geq {d}_{i}} [ {λ}_{i} {D}_{i} ( {μ}_{i}^{2} + {σ}_{i}^{2} ) ] + {( {λ}_{i} {D}_{i} {μ}_{i} )}^{2} ] - {δ}_{τ} {b}_{τ}^{2} \leq 0 ∀ τ \qquad ( 3 )$$

The constraint (3) is a deterministic expression of the requirement that:

Pr{(Bandwidth consumed by customers at time t)>bₜ)≦δₜ

This transformation is carried out by a generalization of the process as set forth starting in the first paragraphs of the detailed description section for the single customer class, single time period case. (Explicit details of this generalization are given in a technical report by the inventors of the present invention—IBM Research Report RJ 10196 (95070) Nov. 2, 2000), herein incorporated by reference.

Objective

The objective of the present invention is to maximize the total revenue minus the purchase cost

$$\text{Maximize} {\sum }_{i , τ} {q}_{i τ} {λ}_{i} ( {q}_{i τ} ) - {\sum }_{τ} {C}_{τ} {a}_{τ} \qquad ( 4 )$$

Referring now to FIG. 1 there is shown a flow diagram showing the data acquisition and input steps according to the present invention for optimizing bandwidth management with multiple types of contracts.

In box 10 the mean and variance of the real usage of each customer class is obtained. In box 12, the price-demand curve data which determines the arrival rate for each customer class is obtained. In box 14, the data on the number of existing customers in each class is obtained. Finally, in box 16, the the bandwidth wholesale cost to the reseller and other items specified in the “Data” section above is obtained.

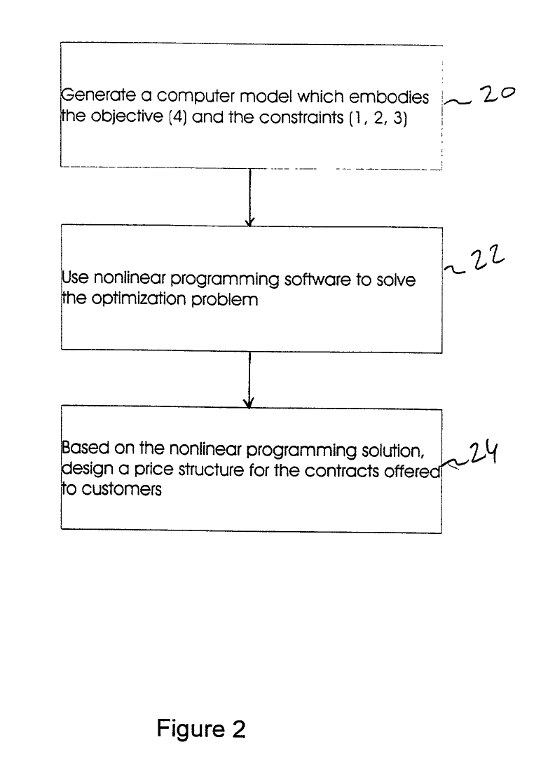

FIG. 2 is a flow diagram showing the optimization steps according to the present invention. In box 20, a computer model is generated which embodies the objective (4) and the constraints (1, 2, 3). Thereafter, in box 22, nonlinear programming software is used to solve the optimization problem. For example, the MINOS nonlinear optimizer available from Stanford Business Software, Inc. is an example of a suitable software package for this model.

Finally, in box 24, based on the non-linear programming solution, design a price structure for the contracts offered to customers. The prices are obtained explicitly from the values of the qᵢₜ variables in the optimal solution, giving prices to be charged by customer class and time period.

### EXAMPLE

As an example, let us take a simple case with a single time period, single customer class, and fixed contract duration, starting at time 0, the available capacity is 10 units. We need to decide how much bandwidth to purchase at time 0 to satisfy demand during the time period [0, 1]. Using arbitrary units, assume the average usage μ of this customer class is 2 units, with variance σ²=1. Also, we assume that it costs 1K dollars to buy each unit of bandwidth. We also specify that at time 0, the initial available bandwidth b₀ is 10 units, and that the tolerance level is δ=0.99. We now need to choose an optimal purchase plan and pricing scheme to maximize our profit.

We recall that price and demand are assumed dependent on each other, and start with the simplest case in which we are to choose between two options:

(A): if we charge each new customer 2.5K dollars, the expected customer number λ will be 20;

(B): if we charge each new customer 2K dollars, the expected number λ will be 30.

Now, which price scheme should be adopted? A or B? In consequence, how much bandwidth a should we purchase to meet the 0.99 tolerance criterion?

Formulating the simplified optimization problem and substituting the given numerical values for the case A in optimization for constraints (1), (2), and (3):

Maximize

20×2.5−a

subject to

20×4+20×1+20×20×4−0.99(10+a)²≦0

and obtain the solution: a=32, b₁=b₀+a=42, and the profit is 18K dollars.

Solving the optimization problem for case B:

Maximize

30×2−a

subject to

30×4+30×1+30×30×4−0.99(10+a)²≦0

we obtain the solution: a=52, b₁=b₀+a=62, and the profit is 8K dollars. Clearly, plan A provides more profit.

In general, demand is continuously sensitive to the price charged, not just for two possibilities A and B as above, and demand and price are believed to be reversely correlated. Taking the above example, and if we assume that price and demand are linearly dependent, then we have

λ₁=λ₁(q₁₁)=70−20q₁₁

or equivalently:

$${q}_{11} ( {λ}_{1} ) = \frac{70 - λ}{20}$$

where λ₁ is the number of customers and the q₁₁ is the price charged to each customer (A and B are 2 special cases of this).

Now, we need to choose the best q₁₁ and a₁ to maximize our profit. The constraints, are

b1=10+a1 (1)

0≦q11 (2)

5λ1+4λ12−0.99b12≦0 (3)

and the objective is

$${max}_{λ \leq 0 , a \geq 0} {q}_{11} ( 70 - 20 {q}_{11} ) - {a}_{1} \qquad ( 4 )$$

This can be solved explicitly (in this case using nonlinear optimizer software, such as MINOS) to obtain the optimal solution:

a=21.15, λ=14.88 and the profit is 19.87K dollars.

According to the present invention capacity planning and pricing policy are directly related to and reflective of the demand of the market. Under the proposed pricing policy, it is in the best interest of the customers to choose the level of the bandwidth service that best reflects their real demand; hence, the capacity planning is more efficient. Further, the pricing scheme provides more flexible choice of the bandwidth service level, allowing certain range of variance. Since the pricing policy is directly related to the real performance of the bandwidth service level, this model provides better control over possible bursts and helps to improve bandwidth management for both the company and the customer. The present invention is preferably implemented in software and of course may comprise computer instructions on a computer readable medium such as a disk, tape, chip or the like.

While the invention has been described in terms of a single preferred embodiment, those skilled in the art will recognize that the invention can be practiced with modification within the spirit and scope of the appended claims.

We claim:

1. A method for optimizing pricing and capacity for bandwidth management using a computer, comprising the steps of:
inputting a mean and a variance of real usage for each of a plurality of customer classes;
inputting price and demand curve data which determines an arrival rate for each customer class;
inputting a number of existing customers in each customer class;
inputting a bandwidth wholesale cost;
generate a computer model for an optimization problem subject to a plurality of predetermined chance constraints;
solving said optimization problem using said computer to determine an amount of bandwidth to be purchased in a time period at a given price for an expected number of new customers in order to maximize profit; and
outputting said amount of bandwidth to be purchased and said expected number of new customers.

2. A method for optimizing pricing and capacity for bandwidth management using a computer as recited in claim 1 wherein said plurality of predetermined chance constraints comprises:
b_{τ}=b_{τ-1}+a_{τ}(τ=1 , . . . , T) (1)
L_{iτ}≦q_{iτ}≦U_{iτ}(i=1, . . . , I; τ=1, . . . , T) (2)
$${\sum }_{i \vert τ < {d}_{i}} [ {λ}_{i τ} Δ {μ}_{i}^{2} + {( {n}_{i τ} + {λ}_{i τ} Δ )}^{2} {σ}_{i}^{2} + {( {n}_{i τ} + {λ}_{i τ} Δ )}^{2} {μ}_{i}^{2} ] + {\sum }_{i \vert τ \geq {d}_{i}} [ {λ}_{i} {D}_{i} ( {μ}_{i}^{2} + {σ}_{i}^{2} ) ] + {( {λ}_{i} {D}_{i} {μ}_{i} )}^{2} ] - {δ}_{τ} {b}_{τ}^{2} \leq 0 ∀ τ \qquad ( 3 )$$
and said optimization problem comprises:
$$\text{Maximize} {\sum }_{i , τ} {q}_{i τ} {λ}_{i} ( {q}_{i τ} ) - {\sum }_{τ} {C}_{τ} {a}_{τ} \qquad ( 4 )$$
wherein:
i=1, . . . , I: customer class;
τ=1, . . . , T: time periods, each of length Δ;
δ_{τ} is tolerance on capacity violation in period τ;
C_{τ} is cost per unit of buying new capacity in period τ;
d_{τ} is duration of contract for customer class i;
Dᵢ is actual duration of contract (dᵢΔ) for customer class i;
n_{iτ} is a number of existing contracts of type i still active at start of period τ;
L_{iτ} is a lower bound on contract price;
U_{iτ} is an upper bound on contract price;
b_{τ} is bandwidth available in period τ;
a_{τ} is bandwidth purchased by re-seller in period τ;
q_{iτ} is price to new or renewing customers for a new standard length contract of type i in period τ; and
λᵢ(q_{iτ}) is expected number of new customers of type i arriving in any period if a price for a contract is set at q_{iτ}.

3. A method for optimizing pricing and capacity for bandwidth management using a computer as recited in claim 1 wherein said computer solving and optimization problem is running a non-linear programming software.

4. A computer readable medium comprising software for causing a computer to execute steps for optimizing pricing and capacity for bandwidth management, comprising the steps of:
receiving a mean and a variance of real usage for each of a plurality of customer classes;
receiving price and demand curve data which determines an arrival rate for each customer class;
receiving a number of existing customers in each customer class;
receiving a bandwidth wholesale cost;
generating a computer model for an optimization problem subject to a plurality of predetermined chance constraints;
solving said optimization problem using said computer to determine an amount of bandwidth to be purchased in a time period at a given price for an expected number of new customers in order to maximize profit; and
outputting said amount of bandwidth to be purchased and said expected number of new customers.

5. A computer readable medium comprising software for causing a computer to execute steps for optimizing pricing and capacity for bandwidth management as recited in claim 4 wherein said plurality of predetermined chance constraints comprises:
b_{τ}b_{τ-1}+a_{τ}(τ=1, . . . , T) (1)
L_{iτ}≦q_{iτ}≦U_{iτ}(i=1, . . . I, . . . , T) (2)
and said optimization problem comprises:
wherein:
$$\begin{matrix}{\sum }_{i \vert τ < {d}_{i}} [ {λ}_{i τ} Δ {μ}_{i}^{2} + {( {n}_{i τ} + {λ}_{i τ} Δ )}^{2} {σ}_{i}^{2} + {( {n}_{i τ} + {λ}_{i τ} Δ )}^{2} {μ}_{i}^{2} ] + {\sum }_{i \vert τ \geq {d}_{i}} [ {λ}_{i} {D}_{i} ( {μ}_{i}^{2} + {σ}_{i}^{2} ) ] + {( {λ}_{i} {D}_{i} {μ}_{i} )}^{2} ] - {δ}_{τ} {b}_{τ}^{2} \leq 0 ∀ τ & ( 3 ) \\ \text{Maximize} {\sum }_{i , τ} {q}_{i τ} {λ}_{i} ( {q}_{i τ} ) - {\sum }_{τ} {C}_{τ} {a}_{τ} & ( 4 )\end{matrix}$$
i=1, . . . , I: customer class;
τ32 1, . . . , T: time periods, each of length Δ;
δ_{τ} is tolerance on capacity violation in period τ;
C_{τ} is cost per unit of buying new capacity in period τ;
d_{τ} is duration of contract for customer class i;
Dᵢ is actual duration of contract (dᵢΔ) for customer class i;
n_{iτ} is number of existing contracts of type i still active at start of period τ;
L_{iτ} is a lower bound on contract price;
U_{iτ} is an upper bound on contract price;
b_{τ} is bandwidth available in period τ;
a_{τ} is bandwidth purchased by re-seller in period τ;
q_{iτ} is price to new or renewing customers for a new standard length contract of type i in period τ; and
λᵢ(q_{iτ})is expected number of new customers of type i arriving in any period if a price for a contract is set at q_{iτ}.

6. A computer readable medium comprising software for causing a computer to execute steps for optimizing pricing and capacity for bandwidth management as recited in claim 4 wherein said computer solving and optimization problem is running a non-linear programming software.
